(19) United States
(12) Patent Application Publication
(10) Pub. No.: US 2007/0079097 A1
(43) Pub. Date: Apr. 5, 2007

(54) Automated logical unit creation and assignment for storage networks

(75) Inventors: Mark Joseph Karnowski, Costa Mesa, CA (US); John Dickson Barnard, Costa Mesa, CA (US)

Correspondence Address: MORRISON & FOERSTER, LLP, 555 WEST FIFTH STREET, SUITE 3500, LOS ANGELES, CA, 90013-1024, US

(73) Assignee: Emulex Design & Manufacturing Corporation, Costa Mesa, CA (US)

(21) Appl. No.: 11/240,022

(22) Filed: Sep. 30, 2005

(51) Int. Cl. G06F 12/00

(52) U.S. Cl. 711/170

(57) ABSTRACT

A single SAN management utility is disclosed that discovers all hosts and HBAs in a SAN, configures the storage switches, creates Logical Units within a storage array, and assigns Logical Units to the hosts in the SAN without requiring the administrator to have a detailed understanding of all of the devices in the SAN or a SAN configuration plan. The SAN management utility may first invoke HBA configuration routines to discover and configure the HBAs in the SAN and determine the hosts in which those HBAs reside. The SAN management utility may then utilize the SAN link to set a new IP address for the storage switch, and then configure the switch over an Ethernet connection. In addition, the SAN management utility may interface with a configuration utility in the storage array through a common storage management specification to create and assign Logical Units in the storage array.

### FIELD OF THE INVENTION

This invention relates to storage area network management, and more particularly, to the automated creation of Logical Units in a storage array and the assignment of those logical drives to hosts in the network.

### BACKGROUND OF THE INVENTION

FIG. 1 is an exemplary illustration of a Storage Area Network (SAN) 100. Exemplary SAN 100 includes four host computers (“servers” or “hosts”) 102, 104, 106 and 108, each host including one or more Host Bus Adapters (HBAs) 112 that are viewed as initiators in the SAN 100. The HBAs 112 provide a means for connecting the hosts to a storage switch 110 such as a Fibre Channel (FC) switch through a link 114 such as a FC link, and ultimately to other devices connected to the storage switch 110. Note that a single host (e.g. host 104) may be connected to the storage switch 112 via multiple HBAs 112, multiple links 114, and multiple switches 110 for redundancy. One such device connected to the storage switch 110 in FIG. 1 is a storage array 116, which is comprised of a plurality of physical disks 118. The storage array includes a controller 120 that performs a number of functions, including creation of logical drives (also known as Logical Unit Numbers (LUNs) or Logical Units) from the physical disks 118 and mapping the logical drives to the hosts. (Note that a LUN, though strictly speaking refers to the number of a Logical Unit, is commonly used to the Logical Unit itself. This document will use the term Logical Unit hereinafter.) The devices in the SAN 100 may also be part of an Ethernet Local Area Network (LAN) 164, shown in FIG. 1 as dashed lines connected via an Ethernet switch 160.

Logical Units are viewed as storage devices in the SAN 100, are apportioned from the plurality of physical disks 118, and manifest themselves as different Logical Unit types. Despite the fact that there are a plurality of physical disks 118 in a storage array, a given host is only able to “see” (and therefore read from and write to) those Logical Units that have been assigned to that host by the storage array 116.

A simple Logical Unit 120 is located on all or part of a single physical disk 118. Simple Logical Units 120 are not fault tolerant, because there is no provision for backing up or recovering data should the single physical disk become faulty.

A spanned Logical Unit 122 is spread out over a number of different physical disks 118. Spanned Logical Units 120 are also not fault tolerant, because there is no provision for backing up or recovering data should one of the different physical disks be lost. Each portion of the spanned Logical Unit 122 on each physical disk 118 may be of a different size. When writing to conventional spanned Logical Units 122, data is written to one physical disk until the portion of the spanned Logical Unit located in that physical disk is filled up with data, then the writing continues in another physical disk until the portion of the spanned Logical Unit located in that physical disk is filled up with data, and so on.

A striped Logical Unit 124 (also known as a Redundant Array of Independent Disks 0 (RAID 0)) is spread out in equal size portions in each of a number of physical disks 118. Striped Logical Units 124 are also not fault tolerant, because there is no provision for backing up or recovering data should one of the physical disks be lost. When a host writes to a conventional striped Logical Unit 124, a portion of the data 126 is written to the portion of the striped Logical Unit located in one physical disk, another portion of the data 128 is written to the portion of the striped Logical Unit located in another physical disk, and so on. By writing only a portion of the data into each physical disk, efficiencies are realized because the need to rotate each physical disk to read or write additional data is reduced.

A mirrored Logical Unit (also known as a RAID 1) includes primary storage areas 130 on physical disks 118 and duplicate storage areas 132 on separate physical disks 118. When writing to conventional mirrored Logical Units, data 134 written to a primary storage area 130 on a primary physical disk is duplicated at 136 on a separate (mirror) physical disk for redundancy. Mirrored Logical Units are fault tolerant, because the data stored in the duplicate physical disks is already present and can be accessed quickly should one of the primary physical disks be lost. However, the capacity of the storage array is reduced by one-half.

A striped Logical Unit with parity (also known as a RAID 5) includes attributes of both a striped Logical Unit and a mirrored Logical Unit. As with striped Logical Units, a striped Logical Unit with parity is spread out in equal size portions 138 in each of a number of physical disks 118. In addition, another portion 140 in another physical disk 148 is reserved for parity data. When writing to conventional striped Logical Units with parity, a portion of the data 142 is written to the portion of the striped Logical Unit located in one physical disk, another portion of the data 144 is written to the portion of the striped Logical Unit located in another physical disk, and so on. In addition, parity data 146 for the portions of data 142 and 144 is written to the physical disk 148 reserved for parity data. By storing this parity data 146, if any one of the data portions 142 or 144 is lost due to a physical disk failure, the lost data can be regenerated by the storage array. A spare physical disk 150 can then replace the failed physical disk and store the regenerated data.

Configuration of a SAN. In order to make the SAN 100 operational, the HBAs 112, storage switch 110, storage array 116 and any other devices within the SAN 100 must be configured using separate configuration utilities. However, before any devices can be configured, they must be discovered. When each of the HBAs 112, storage array 116, and other network devices are brought on line in the SAN 100, each network device logs in to the storage switch 110 and provide the storage switch 110 with its world-wide port name (world-wide unique address) and certain attributes (e.g. target or initiator), enabling the storage switch 110 to create a list of all network devices in the SAN 100.

Configuration of HBAs. In a conventional SAN 100, in order to configure the HBAs 112, an HBA configuration utility such as Emulex Corporation's HBAnyware® (see U.S. Published Application No. 20040103220, incorporated herein by reference) may be executed from one of the hosts. HBAnyware® may query the storage switch 110 to obtain the list of network devices in the SAN 100. From the list of devices obtained from the switch, those Hosts that contain an HBAnyware® agent are identified. The HBAnyware® utility may then send requests to the Hosts containing the HBAnyware® agent to discover additional attributes such as the host in which the agent resides. The end result is that a list of hosts, and HBAs resident in those hosts, is obtained.

Configuration of the storage switch. In a conventional SAN 100, the storage switch 110 is generally not configured over a SAN link such as a° FC link 114, but rather over an Ethernet connection. Web pages generated by the storage switch 110 are used by SAN administrators to configure the storage switch 110. However, when the storage switch 110 is first connected to the SAN 100 and Ethernet LAN 164 and brought on line, it may contain a factory-installed generic IP address which is not recognized by devices on the Ethernet LAN 164. Because the unrecognized generic IP address of the storage switch 110 does not allow Ethernet devices to communicate with and configure the storage switch 110, it is first necessary to set the IP address of the storage switch 110 to an address recognizable by devices on the Ethernet LAN 164. This is accomplished by connecting a personal computer (PC) 166 or similar device directly to the storage switch 110 using a serial port or Ethernet port, and running a utility to set the IP address. Once this is accomplished, the PC .166 can be disconnected from the storage switch, and an Ethernet connection can be established. With the new IP address, the storage switch 110 is recognizable on the Ethernet LAN 164, and the storage switch 110 may be configured over the Ethernet connection.

Configuration of storage arrays. In a conventional SAN 100, the storage array 116 must also be configured using a separate configuration utility. However, because different storage arrays may have different vendor-specific proprietary interfaces, it can be difficult and inefficient to write utilities that interface directly with each of the different storage arrays. As a result, various tools have been developed to assist in the configuration process. For example, Microsoft's® Virtual Disk Service (VDS) 152 provides a common storage management specification that enables storage management applications 154 to be written to manage storage arrays from within the Windows Serverυ 2003 operating system (OS) running on a single host (e.g. host 102). The storage management applications 154 communicate with a VDS Application Programming Interface (API) 156 to access VDS 152. The VDS API 156 translates storage management application commands to generic VDS commands executable in VDS 152. VDS 152 then interacts (using the VDS API 156) with VDS provider software 158, written by the storage array vendor but resident in the host, to configure that particular storage array. The VDS provider software 158 translates generic VDS commands to vendor-specific proprietary commands executable by a configuration utility 162 in the storage array 116. These vendor-specific commands may be sent over SAN link 114, or may be sent over an Ethernet connection through Ethernet switch 160 to the storage array 116.

To configure the storage array 116, a SAN administrator must first create Logical Units. To do this, the SAN administrator may run a separate proprietary utility running on one of the hosts (e.g. host 102) to send commands to the storage array 116 through the storage switch 110 to create a Logical Unit. As described above, these commands may be executed through a common storage management specification such as VDS 152. Alternatively, if the storage array 116 is connected to an Ethernet switch 160 and has an IP address, the storage array 116 may provide a web page as an interface to enable to a SAN administrator, via host 102, for example, to input information related to the creation of a Logical Unit. In either case, the SAN administrator must specify parameters that may include one or more of the following: the type of Logical Unit, its size, how many physical disks are to be used to create the Logical Unit, the amount of storage to be held in reserve for expansion, and the like. The commands may be received by a proprietary configuration utility 162 in the storage array 116, which then creates the Logical Unit in the storage array 116 accordingly. If multiple Logical Units are desired, the SAN administrator must repeat this process for each Logical Unit.

Although a host (e.g. host 102) may have directed the creation of one or more Logical Units by the storage array 116, until the Logical Units are assigned to a particular host, the Logical Units may not be initially recognizable by the operating system in any of the hosts. Therefore, the next step is for the SAN administrator to assign Logical Units to hosts.

To assign Logical Units to hosts, the SAN administrator must have knowledge of the created Logical Units and all the HBAs in the SAN, and may utilize one of the hosts (e.g. host 102) to send commands to the storage array 116 through the storage switch 110 to make the desired assignments. As mentioned above, a web page may be employed as an interface to enable to a SAN administrator to input information related to the assignment of Logical Units to hosts, including the world-wide port names of the HBAs within the hosts. In either case, commands may be received by a proprietary utility executed in the storage array 116, which then assigns a Logical Unit in the storage array to a host. This process is called Logical Unit or LUN unmasking, because a particular Logical Unit is unmasked to a host. Typically, each Logical Unit is assigned to a particular host (i.e. the Logical Units are not shared by hosts), and the assignments are performed one at a time. Note, however, that hosts with multiple HBAs often require that the same Logical Unit be assigned to all HBAs within a particular host to allow redundant connections to a Logical Unit. (It is also possible to “unmask” the LUN to all hosts. This means the LUN will be seen by any HBAs on the SAN. However, this is not a desirable way to assign LUNs.)

If more than one assignment of a Logical Unit to a host desired, the SAN administrator must repeat the process described above for each assignment. Each time a Logical Unit has been assigned to a host (and therefore to an HBA), the storage array will update a list containing all of the HBAs that are allowed access to each Logical Unit.

As the above description indicates, separate utilities must be run by a SAN administrator to configure the HBAs, storage switches, and storage arrays in a SAN. Furthermore, to configure a storage array by creating Logical Units and assigning them to hosts, the SAN administrator may need to know the type of Logical Unit, its size, how many physical disks are to be used to create the Logical Unit, the amount of storage to be held in reserve for expansion, all the HBAs in the SAN and their world-wide port names, which HBAs are resident in which hosts, and the desired assignment of Logical Units to hosts, and must create Logical Units one at a time and assign Logical Units to hosts one at a time. While knowledge of the SAN devices and parameters and a SAN-wide configuration plan and the execution of separate utilities to configure the HBAs, storage switches and storage arrays in a SAN may be well within the capabilities of sophisticated SAN administrators, this knowledge and the burden of the overall configuration process may be beyond the reach of inexperienced SAN administrators. In other instances, the SAN administrator may not want to spend the time to create a custom configuration for the SAN.

In an attempt to ease the burden of running separate utilities, conventional SAN configuration utilities have been developed to configure the HBAs, storage switches, and storage arrays in a single application. However, these conventional SAN configuration utilities still require the SAN administrator to have detailed knowledge of the SAN devices and parameters and a SAN-wide configuration plan. In addition, conventional storage array configuration utilities have been developed (e.g. Hewlett-Packard's Array Configuration Utility (ACU)), but these utilities have no knowledge of how many hosts or HBAs exist, and the association between hosts and HBAs. Such utilities are therefore incapable of making SAN-wide configuration decisions, and can only create and assign a Logical Unit for a single host based only on the amount of storage available. To properly utilize such a utility, the SAN administrator must have the detailed knowledge described above.

Therefore, there is a need for a SAN configuration utility that is able to configure the HBAs, storage switches, and storage arrays in a SAN in a single application in a simplified manner that is able to automatically determine the addresses and number of HBAs and hosts in the SAN and does not require detailed knowledge of the SAN devices and a SAN-wide configuration plan.

### SUMMARY OF THE INVENTION

Embodiments of the present invention are directed to a single SAN management utility that discovers all hosts and HBAs in a SAN, configures the storage switches, creates Logical Units within a storage array, and assigns Logical Units to the hosts in the SAN, all without the need to run separate HBA, storage switch, and storage array configuration utilities, and without the need for a detailed understanding of all of the devices in the SAN or a SAN configuration plan.

The SAN management utility may first attempt to obtain as much information about the SAN as it can without input from the SAN administrator. To accomplish this, the SAN management utility may issue commands to the switch 110 and subsequently to HBAnyware agents on other hosts to discover and configure the HBAs in the SAN and determine the hosts in which those HBAs reside.

The SAN management utility may then utilize the SAN link 114 to issue commands to the switch to set a new IP address for the storage switch 110, and then call up the web pages of a storage switch configuration utility over an Ethernet connection to configure the switch.

In addition, the SAN management utility may interface with a proprietary configuration utility in the storage array through a common storage management specification (e.g. VDS) to create and assign Logical Units in the storage array. It should be noted that although VDS is the common storage management specification described herein for purposes of illustration and explanation only, other common storage management specifications may also be utilized and fall within the scope of the present invention. In alternative embodiments, the SAN management utility may utilize web pages provided by the storage array through an Ethernet connection to interface with the proprietary storage array configuration utility. In still further alternative embodiments, the storage management application may communicate directly with the proprietary device configuration utility to create and assign Logical Units in the storage array. In any case, because much of the information about the SAN has been obtained in advance, without input from the SAN administrator, the SAN management utility need only ask a few simple “high-level” questions of the SAN administrator before creating and assigning the Logical Units to hosts.

### BRIEF DESCRIPTION OF THE DRAWINGS

FIG. 1 is an exemplary illustration of a Storage Area Network (SAN) that includes four host computers (“servers” or “hosts”), each host including one or more Host Bus Adapters (HBAs) that are viewed as initiators in the SAN.

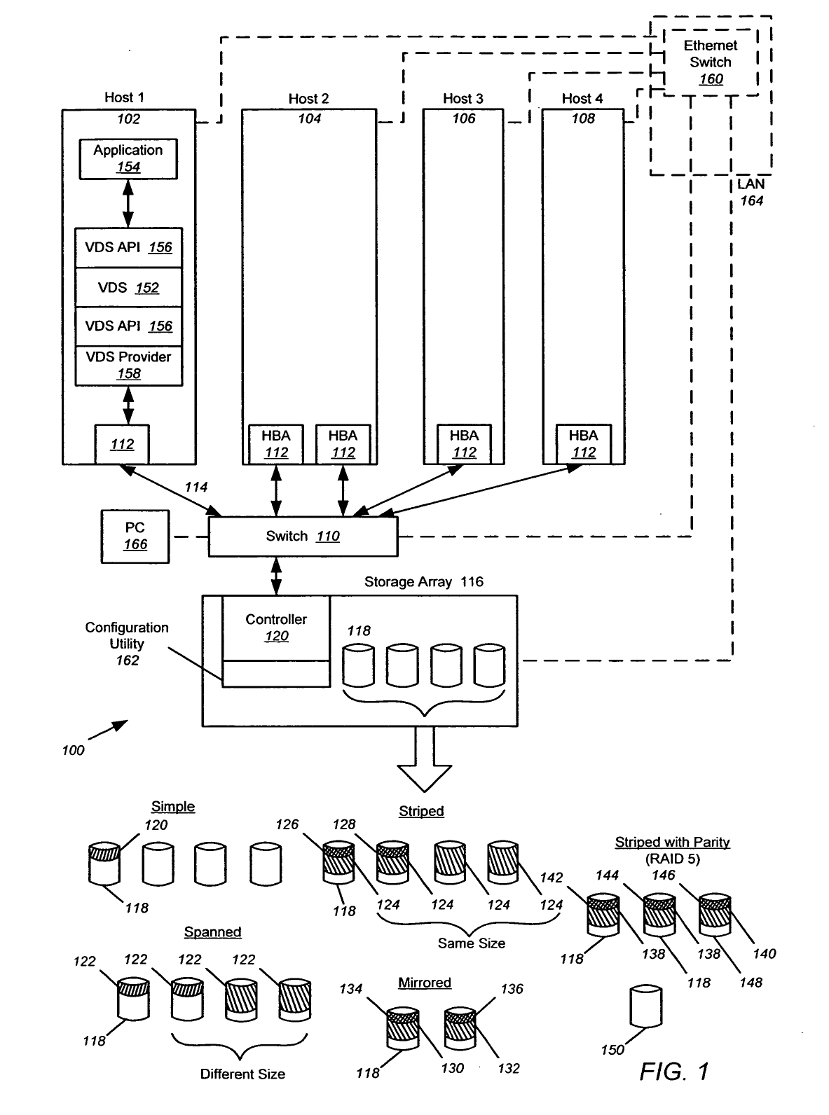

FIG. 2a is an exemplary illustration of a SAN and the SAN management utility according to embodiments of the present invention.

FIG. 2b is an exemplary flowchart of a storage array configuration utility according to embodiments of the present invention.

### DETAILED DESCRIPTION OF THE PREFERRED EMBODIMENT

In the following description of preferred embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the preferred embodiments of the present invention.

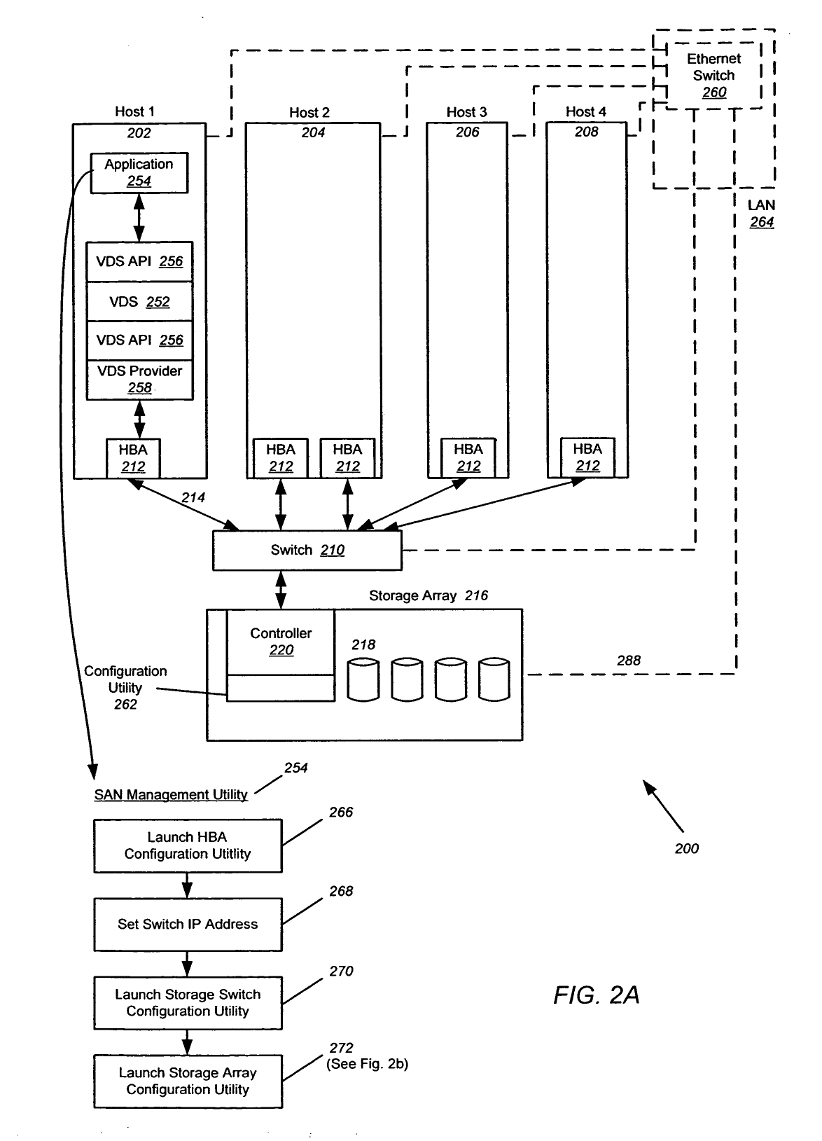

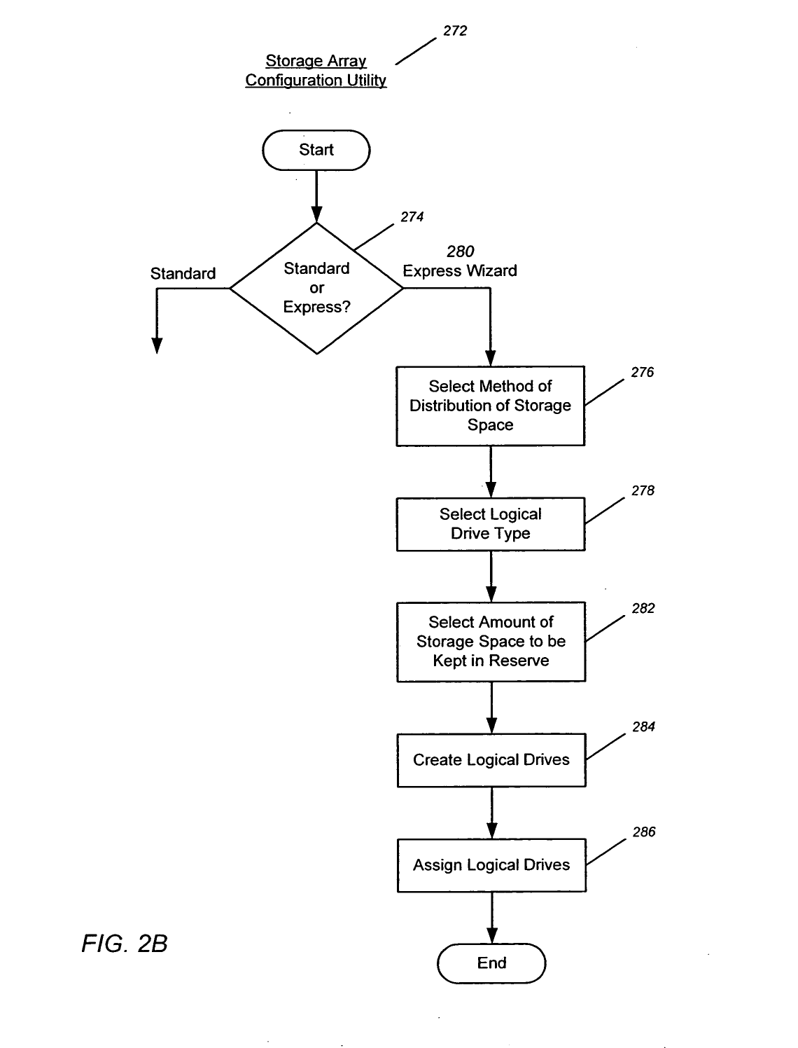

FIG. 2a is an exemplary illustration of a SAN 200 according to embodiments of the present invention. Exemplary SAN 200 includes four hosts 202, 204, 206 and 208, each host connected to a storage switch 210 through Fibre Channel (FC) connections 214 and one or more Host Bus Adapters (HBAs) 212 that are viewed as initiators in the SAN 200. The storage switch 210 is also connected to a storage array 216, which is comprised of a plurality of physical disks 218. The storage array also includes a controller 220 that performs a number of functions, including the mapping of physical disks 218 to Logical Units, and the mapping of Logical Units to hosts. Logical Units are viewed as targets in the SAN 200, are apportioned from the plurality of physical disks 218, and have different Logical Unit types. The devices in the SAN 200 may also be part of an Ethernet Local Area Network (LAN) 264, shown in FIG. 2a as dashed lines connected via an Ethernet switch 260.

To utilize the SAN management utility according to embodiments of the present invention, a SAN administrator must first decide which host (e.g. host 202 in the example of FIG. 2a ) will be used to manage the SAN 200, then install software into all other hosts (e.g. hosts 204, 206 and 208 in FIG. 2a ), and finally install software including the SAN management utility 254 according to embodiments of the present invention into the host chosen to manage the SAN 100.

Configuration of HBAs. To configure the HBAs 212 according to embodiments of the present invention, HBA configuration routines 266 may be invoked or launched from within the SAN management utility 254 from one of the hosts. These HBA configuration routines may query the storage switch 210 to obtain the list of network devices in the SAN 200. From the list of devices obtained from the switch, those HBAs that contain an agent are identified. The HBA configuration routines may then send requests to the HBAs containing the agent to discover additional attributes such as the host in which the HBA resides. The end result is that a list of hosts, and HBAs resident in those hosts, is obtained. Knowledge of the existence and location of the resident HBAs in the SAN allows management of these HBAs in a conventional manner as described in the above-referenced patent application.

Configuration of storage switch. As described above, the conventional approach to configuring a storage switch involves connecting a PC or similar device to the storage switch using a serial port or Ethernet port, and running a utility to set the IP address. Once this is accomplished, the PC can be disconnected from the storage switch, and an Ethernet connection can be established. With the new IP address, the storage switch is recognizable on the Ethernet LAN 264, and the storage switch may be configured over the Ethernet connection. This conventional process requires that the SAN administrator make an inconvenient, time-consuming one-time connection to the storage switch for the single purpose of assigning a new IP address to the switch.

Embodiments of the present invention eliminate this additional connection step by utilizing a SAN link (e.g. a FC link) to assign a new IP address to the storage switch (see reference character 268 in FIG. 2a). First, the SAN management utility queries the storage switch over the FC link, which should initially indicate that the switch is unconfigured. Inband Fibre Channel commands (Common Transport (CT) commands) are then sent to the storage switch, which includes the new IP address of the switch, to set a new IP address for the storage switch. (Note that while CT commands are one way to set up the switch, there are other ways. For example, SCSI transport mechanisms may be used to configure switches.) With the new IP address, the storage switch is now available over the Ethernet network. The SAN management utility can then hierarchically display all devices in the SAN based on the list of devices obtained from the storage switch, and by clicking on the icon of one of the switches, call up a storage switch configuration utility 270 (e.g. Brocade's storage switch configuration utility EZSwitch Setup incorporated by reference herein) over the Ethernet connection to configure the switch. The storage switch configuration utility may have a Graphical User Interface (GUI) appearing on web pages generated within the storage switch. The web pages can be made to appear in a window as part of the SAN management utility, although they are actually running in the storage switch.

Storage array configuration. In embodiments of the present invention, the SAN management utility 254 may launch a storage array configuration utility 272 that interfaces with a proprietary configuration utility in the storage array 216 through a common storage management specification (e.g. VDS) in order to create Logical Units and assign the created Logical Units to hosts. In alternative embodiments, the SAN management utility 254 may utilize web pages provided by the storage array 216 through an Ethernet connection 288 to interface with the proprietary storage array configuration utility. In still further alternative embodiments, the storage management application may communicate directly with the proprietary device configuration utility to create and assign Logical Units in the storage array.

In any case, the configuration of the storage array 216 according to embodiments of the present invention can take various approaches. In a “standard” approach best suited for the sophisticated SAN administrator with detailed knowledge of the SAN 200 and an idea of how the SAN 200 is to be configured, the Logical Units in the SAN 200 can be created and assigned one at a time, to one or more hosts in the SAN, and subsequently managed. In an “express” approach best suited for the inexperienced SAN administrator without detailed knowledge of the SAN 200 or an idea of how the SAN 200 is to be configured, or for the SAN administrator who does not want to spend the time needed for a custom configuration, all Logical Units in the SAN 200 can be configured at the same time. Further, even a sophisticated SAN administrator may want to quickly setup a baseline configuration for an entire SAN, then adjust configurations only when they vary from the baseline. Referring now to FIG. 2b , which illustrates an exemplary flowchart of a storage array configuration utility according to embodiments of the present invention, a screen may appear that enables a SAN administrator to select either the express or standard approach (see reference character 274), and may provide a short explanation of the setup that will occur if either approach is selected.

“Express” storage configuration wizard. If the express approach is selected, an Express storage configuration wizard 280 is launched that may first prepare itself to divide the available storage evenly to create a Logical Unit for each host in the SAN (see reference character 276). However, in other embodiments, other approaches may be employed, such as an uneven allocation of the available storage (e.g. allocating more disk space to certain key hosts) and the like. The Express storage wizard may provide the SAN administrator with additional screens that enable to SAN administrator to select these other approaches.

The SAN administrator may then be presented with a screen that enables selection of the Logical Unit type (see reference step 278). Choices may include, but are not limited to, simple, spanned, striped, mirrored, and striped with parity Logical Units, along with a short description of each Logical Unit type. Note that the Express storage configuration wizard knows the type of storage array from the discovery process, and therefore also knows what Logical Unit types are supported by that storage array. Logical Unit type choices that are not available based on the type of storage array being configured may be “grayed-out” or not present or otherwise unavailable.

In alternative embodiments, a functional approach may be employed, where the SAN administrator is given a set of statements or goals such as “maximize available storage,” “maximize performance,” “balance storage and performance,” or “maximize the recovery time from a disk failure,” and is then asked to pick the statement or goal that best describes the SAN administrator's present need. After a particular statement or goal has been selected, the SAN administrator may be presented with further statements or goals to further refine the needs of the SAN administrator. In other words, the SAN administrator may be asked to traverse a tree of questions in order for the Express storage configuration wizard to determine the Logical Unit type best suited to the needs of the SAN administrator. [mark's note: do we need to provide examples of the questions?] “Details” buttons may be provided to give the SAN administrator further information about each choice.

After the Logical Unit type has been selected, the Express storage configuration wizard 280 may also query the SAN administrator for the amount of storage space to be kept in reserve for future expansion (see reference character 282). The SAN administrator may be able to enter a percentage of storage space or a fixed amount of storage space to be kept in reserve. In other embodiments, the SAN administrator may be asked whether an entire spare physical disk (or a number of spare disks) is to be reserved. Note that if the chosen Logical Unit type is “simple,” this choice may not be available because only one disk is used. If VDS is used, the Express storage configuration wizard may then provide the number of physical disks available and the Logical Unit type and query the storage array through VDS to determine the largest Logical Unit that can be created, given the selected Logical Unit type and the storage space on the number of available physical disks.

After the SAN administrator has answered all the questions, the Express storage configuration wizard 280 creates the Logical Units (see reference character 284). Additionally, all of the created Logical Units are automatically assigned to hosts (see reference character 286). For example, suppose that the SAN administrator has elected to divide the available storage evenly to create a Logical Unit for each host in the SAN, has selected striped with parity Logical Units, and has elected to keep 20% of the available space reserved for additional growth. If 400 GBytes of total storage in four 100 GByte physical disks are available and there are two hosts in the system, then according to embodiments of the present invention one 100 GByte physical disk would be reserved as a spare to store regenerated data, and 60 GBytes (20% of the 300 GBytes on the remaining three physical disks) across all three physical disks would be reserved for future growth. The 240 GBytes of unreserved storage in the remaining three physical disks would be divided evenly among two Logical Units, with one of the three physical disks designated to store parity data for each Logical Unit. Thus, each of the two Logical Units would contain 120 GBytes, and would be assigned to one of the hosts. Note that while the drives would each use 120 GB of space, their capacity would only be 80 GB since ⅓ of the space is used for parity data.

Although the SAN administrator sees the creation and assignment of Logical Units as a one-step process, separate VDS commands may be executed in a manner transparent to the SAN administrator to create each Logical Unit, one at a time, and assign each Logical Unit, one at a time.

Extending the present invention. In alternative embodiments of the present invention, the express storage configuration wizard could be utilized to create and assign Logical Units for Just a Bunch of Disks (JBODs). For purposes of this discussion, a JBOD could be considered a storage array without a storage control. In this alternative embodiment, controller software in the host substitutes for the array controller. For example, a SAN may comprise a quantity of hosts and four JBODs rather than one storage array. Because each JBOD can be defined as a single Logical Unit, and no further granularity of Logical Units is available, the express storage configuration wizard would create four Logical Units, one for each JBOD, and could assign each of these Logical Units to a host. In this case the controller software in the hosts would be programmed to unmask the Logical Unit that is intended for that host. Each of the four drives would be assigned to separate hosts. Whereas the assignment of a host to a LUN is stored and enforced by the storage array, this assignment would be done and enforced through the OS and storage driver running on the host.

In a further embodiment of the present invention, the express storage configuration wizard could be further utilized to more completely prepare the Logical Units. The further operations of partitioning and formatting the Logical Units will further simplify SAN configuration.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention as defined by the appended claims.

What is claimed is:

1. A method for express configuration of a storage array, comprising:
providing a first user interface for enabling a Storage Area Network (SAN) administrator to automatically configure the storage array with regard to dividing an available amount of storage for creating a Logical Unit for each host computer capable of accessing the storage array, selecting a Logical Unit type for the Logical Units to be created, and reserving an amount of storage for future expansion.

2. The method as recited in claim 1, further comprising:
presenting a selection screen to the SAN administrator via the first user interface for dividing the available amount of storage evenly among the hosts.

3. The method as recited in claim 1, further comprising:
presenting a selection screen to the SAN administrator via the first user interface for dividing the available amount of storage among the hosts in an uneven manner.

4. The method as recited in claim 1, further comprising:
presenting a selection screen to the SAN administrator via the first user interface for selecting either a simple, spanned, striped, mirrored, or striped with parity Logical Unit type.

5. The method as recited in claim 1, further comprising:
presenting a selection screen to the SAN administrator via the first user interface for selecting only those Logical Unit types supported by the storage array.

6. The method as recited in claim 1, further comprising:
presenting a selection screen to the SAN administrator via the first user interface for selecting only those Logical Unit types supported by a storage management specification utilized by the user interface to communicate with the storage array.

7. The method as recited in claim 1, further comprising:
presenting a selection screen to the SAN administrator via the first user interface that provides one or more functional statements or goals for use in selecting a Logical Unit type.

8. The method as recited in claim 1, further comprising:
presenting a selection screen to the SAN administrator via the first user interface for selecting a user-configurable or fixed amount of storage space.

9. A method for SAN management including the express configuration method of claim 1, the method further comprising:
providing a second user interface for enabling the SAN administrator to select between the express configuration method and a standard configuration method.

10. The method as recited in claim 9, further comprising utilizing a SAN link to assign a new Internet Protocol (IP) address to a storage switch connected to the storage array by:
querying the storage switch for a database that includes a well-known name for the storage switch; and
issuing commands to the storage switch to set a new IP address for the storage switch.

11. The method as recited in claim 10, further comprising configuring the storage switch by utilizing an Ethernet connection to execute a storage switch configuration utility residing in the storage switch.

12. The method as recited in claim 10, further comprising configuring Host Bus Adapters (HBAs) coupled to the storage switch by executing an HBA configuration utility.

13. One or more storage media including a computer program which, when executed by one or more processors, provides for an express configuration of a storage array by causing the one or more processors to:
present a first user interface for enabling a Storage Area Network (SAN) administrator to automatically configure a storage array with regard to dividing an available amount of storage for creating a Logical Unit for each host computer capable of accessing the storage array, selecting a Logical Unit type for the Logical Units to be created, and reserving an amount of storage for future expansion.

14. The one or more storage media as recited in claim 13, wherein the computer program, when executed by one or more processors, further causes the one or more processors to present a selection screen to the SAN administrator via the first user interface for dividing the available amount of storage evenly among the hosts.

15. The one or more storage media as recited in claim 13, wherein the computer program, when executed by one or more processors, further causes the one or more processors to present a selection screen to the SAN administrator via the first user interface for dividing the available amount of storage among the hosts in an uneven manner.

16. The one or more storage media as recited in claim 13, wherein the computer program, when executed by one or more processors, further causes the one or more processors to present a selection screen to the SAN administrator via the first user interface for selecting either a simple, spanned, striped, mirrored, or striped with parity Logical Unit type.

17. The one or more storage media as recited in claim 13, wherein the computer program, when executed by one or more processors, further causes the one or more processors to present a selection screen to the SAN administrator via the first user interface for selecting only those Logical Unit types supported by the storage array.

18. The one or more storage media as recited in claim 13, wherein the computer program, when executed by one or more processors, further causes the one or more processors to present a selection screen to the SAN administrator via the first user interface for selecting only those Logical Unit types supported by a storage management specification utilized by the user interface to communicate with the storage array.

19. The one or more storage media as recited in claim 13, wherein the computer program, when executed by one or more processors, further causes the one or more processors to present a selection screen to the SAN administrator via the first user interface that provides one or more functional statements or goals for use in selecting a Logical Unit type.

20. The one or more storage media as recited in claim 13, wherein the computer program, when executed by one or more processors, further causes the one or more processors to present a selection screen to the SAN administrator via the first user interface for selecting either a user-configurable or fixed amount of storage space.

21. The one or more storage media as recited in claim 13, wherein the computer program, when executed by one or more processors, further causes the one or more processors to provide a second user interface for enabling the SAN administrator to select between the express configuration of the storage array and a standard configuration of the storage array.

22. The one or more storage media as recited in claim 21, wherein the computer program, when executed by one or more processors, further causes the one or more processors to utilize a SAN link to assign a new Internet Protocol (IP) address to a storage switch connected to the storage array by:
querying the storage switch for a database that includes a well-known name for the storage switch; and
issuing commands to the storage switch to set a new IP address for the storage switch.

23. The one or more storage media as recited in claim 22, wherein the computer program, when executed by one or more processors, further causes the one or more processors to configure the storage switch by utilizing an Ethernet connection to execute a storage switch configuration utility residing in the storage switch.

24. The one or more storage media as recited in claim 22, wherein the computer program, when executed by one or more processors, further causes the one or more processors to configure Host Bus Adapters (HBAs) coupled to the storage switch by executing an HBA configuration utility.

25. In a host couplable to a storage array through a storage switch, one or more processors in the host programmed for express configuration of the storage array by:
providing a first user interface for enabling a Storage Area Network (SAN) administrator to automatically configure the storage array with regard to dividing an available amount of storage for creating a Logical Unit for each host computer capable of accessing the storage array, selecting a Logical Unit type for the Logical Units to be created, and reserving an amount of storage for future expansion.

26. The one or more processors as recited in claim 25, further programmed for:
presenting a selection screen to the SAN administrator via the first user interface for dividing the available amount of storage evenly among the hosts.

27. The one or more processors as recited in claim 25, further programmed for:
presenting a selection screen to the SAN administrator via the first user interface for dividing the available amount of storage among the hosts in an uneven manner.

28. The one or more processors as recited in claim 25, further programmed for:
presenting a selection screen to the SAN administrator via the first user interface for selecting either a simple, spanned, striped, mirrored, or striped with parity Logical Unit type.

29. The one or more processors as recited in claim 25, further programmed for:
presenting a selection screen to the SAN administrator via the first user interface for selecting only those Logical Unit types supported by the storage array.

30. The one or more processors as recited in claim 25, further programmed for:
presenting a selection screen to the SAN administrator via the first user interface for selecting only those Logical Unit types supported by a storage management specification utilized by the user interface to communicate with the storage array.

31. The one or more processors as recited in claim 25, further programmed for:
presenting a selection screen to the SAN administrator via the first user interface for providing one or more functional statements or goals for use in selecting a Logical Unit type.

32. The one or more processors as recited in claim 25, further programmed for:
presenting a selection screen to the SAN administrator via the first user interface for selecting either a user-configurable or fixed amount of storage space.

33. The one or more processors as recited in claim 25, further programmed for SAN management by:
providing a second user interface for enabling the SAN administrator to select between the express configuration method and a standard configuration method.

34. The one or more processors as recited in claim 33, further programmed for utilizing a SAN link to assign a new Internet Protocol (IP) address to a storage switch connected to the storage array by:
querying the storage switch for a database that includes a well-known name for the storage switch; and
issuing commands to the storage switch to set a new IP address for the storage switch.

35. The one or more processors as recited in claim 34, further programmed for configuring the storage switch by utilizing an Ethernet connection to call up a storage switch configuration utility residing in the storage switch.

36. The one or more processors as recited in claim 34, further programmed for configuring Host Bus Adapters (HBAs) coupled to the storage switch by executing an HBA configuration utility.

37. A SAN comprising the host of claim 25, the SAN further comprising:
a storage switch coupled to the host; and
a storage array coupled to the storage switch.
